(19) United States
(12) Patent Application Publication
(10) Pub. No.: US 2005/0242463 A1
(43) Pub. Date: Nov. 3, 2005

(54) Method and apparatus to produce starter strips and decorative mouldings

(76) Inventor: David Schmidt, Fenwick (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/964,649

(22) Filed: Oct. 15, 2004

(30) Foreign Application Priority Data
Apr. 29, 2004 (CA) 2,465,596

(51) Int. Cl. B29C 41/30

(52) U.S. Cl. 264/171.13; 425/115

(57) ABSTRACT

A method and apparatus to produce starter strips and decorative mouldings that are widely used in the construction industry. The method is a sequence of advancing a core, constructed from pre-formed expanded polystyrene (EPS), in a straight horizontal plane through a coating chamber with constraining devices preventing lateral and vertical movement. The coating chamber is filled with a thick liquid stucco or plaster or cement-like mixture and imparts a layer of the liquid onto the preformed core. The thickness of the coating is controlled with templates having an opening correspondingly larger than the core size and with the desired profile. The apparatus can be configured to coat a portion of an elongate surface in the case of producing a starter strip. In the case of a decorative moulding, the coating application can be limited to the exposed decorative surfaces only. The templates are designed to be interchangeable with other coating apparatus to produce starter strips, decorative mouldings, wall panel sections and columns commonly used in the construction industry.

### FIELD OF THE INVENTION

This invention relates to the construction industry and is used to produce starter strips and decorative mouldings comprised of pre-formed expanded polystyrene (hereinafter referred to as EPS) cores with a stucco/plaster/cement-like coating. The invention relates particularly to a method and apparatus for coating the cores with stucco/plaster/cement.

### BACKGROUND OF THE INVENTION

The externally insulated finishing systems (hereinafter referred to as EIFS) construction basically consists of framing a building and covering the outside surface with a backboard that may be plywood, gypsum or cement board prior to attaching the exterior insulation and finish.

The exterior insulation consists of EPS sheets mechanically or adhesively attached to the backboard. The EPS sheets are then covered with one or two layers of cloth mesh and a base coat of stucco.

The base coat is either sprayed or trowelled on and finished smooth by hand with a float. A finish stucco material is then applied to give the desired decorative surface and colour.

One of the building code requirements in this construction system is that the EPS sheets that abut any openings such as windows, doors, expansion joints, corners, wall terminations, etc. have the stucco base coat extend underneath and along the edge of such terminations.

The common method of achieving this is to apply mesh to the backboard along these edges. Stucco base coat is then trowelled on and the EPS sheet is placed along the edge. The mesh is then folded over the edge and on to the top of the sheet. This is a very labour intensive and messy process.

The concept of a starter strip is to cut a length of the EPS sheet, up to twenty-four inches wide, and pre-apply the coating to a four inches wide section along the back surface and its adjacent edge. The starter strips can then be applied directly at the terminating edges, thus eliminating much of the fieldwork.

This invention discloses a process and apparatus for applying the coated section to the starter strip. The apparatus is small and lightweight so that the starter strips may be made on site and adhere to the walls while still wet. The apparatus is also versatile enough to produce decorative mouldings.

Decorative mouldings are preformed and finished, ready to be installed on the construction site. They are typically comprised of an expanded polystyrene (EPS) core and coated with a plaster or stucco-like material to provide an attractive decorative finished surface. To improve strength and durability, a fibre mesh can be applied to the core prior to coating.

The prevalent method of producing a decorative moulding is to align rows of the cores on plastic topped tables and staple or screw them to the tabletop. There could be as many as four rows of cores places side by side on a four foot wide table, extending up to ninety feet long or more. If required, the cores would have had mesh applied prior to placing on the table.

The coating material is poured from a pail along the length of the cores and massaged by hand on to the exposed surfaces of the cores. A box, with a steel template cut to a finish profile, is then slid along the length of the table, thus imparting the finished profile on the workpiece. The workpiece is allowed to dry, and another coating can be applied with a finer grained material to impart a smoother finish.

After allowing the workpiece to completely dry, it is pried off the table. The edges that were defined by the tabletop can be sanded and any minor imperfections can be repaired.

This whole process usually takes twenty-four hours and requires clean up after of the tabletops, removal of the screws, cleaning the box and template. This method is very costly, in terms of labour and space.

More recently, various types of automated equipment have been produced to apply the coating. For example Canadian patent application 2229933 filed Feb. 19, 1998 by Oscar et. al., discloses a method and apparatus for coating a decorative workpiece. This apparatus drives a core through a coating chamber with a pair of conveyor belts with spikes penetrating the core from the bottom surface. The core is driven through a pressurized coating chamber by the conveyor belts. An elongate channel or dovetail is pre-cut in the bottom of the core that engages on a corresponding rail on the apparatus, and holds the core against lateral and vertical movement as it is coated. While this method and apparatus does provide a coating on the decorative surface of the workpiece, in practise it can be very troublesome. If the cores are not tightly placed end to end with each other as they pass through the coating chamber, the coating material leaks on to the conveyor belts and rail. The leaked material can accumulate as lumps on the belts and impart an uneven finish on the workpiece. Furthermore, as the last core passes through the coating chamber, all the excess material falls onto the rail and spiked belts thus requiring a meticulous cleanup.

Additionally, the apparatus disclosed in Canadian patent application 2229933 does not allow for coating the underside of a core or producing starter strips, and is extremely limited in its application in coating decorative inside corner mouldings. Also, an undesirable channel or dovetail is required on the underside of the core. Furthermore, because the ends of the coating chamber are angled, the templates are not easily produced because of the complicated rendering of the resulting perpendicular section required on the workpiece.

Canadian patent 2184205 issued on Jan. 27, 1998 and reissued on Sep. 7, 1999 to 888804 Ontario Limited, discloses a method and apparatus for manufacturing decorative mouldings. In this method, the workpiece is driven by conveyor belts abutting both sides of the workpiece before passing through a coating chamber while being slidingly engaged with a continuous flat tabletop. While this apparatus does provide a coating on the decorative surface of the workpiece, it is also troublesome and limited in its application. Firstly, if the cores are not tightly butted up against each other, end to end, the coating material leaks on to the tabletop, accumulates and affects the thickness of the coating. Holding the cores against the tabletop as they pass through the coating chamber creates friction that makes the cores harder to drive through the coating chamber. For inside corner mouldings, the conveyor belts can only drive against two corners on the sides of the core. The belts rip the corners of the core before entering the coating chamber. Slipping can occur which results in an uneven surface finish. Pieces of the core are carried into the coating chamber and contaminate the mix. The dies as illustrated in the patent with tapered openings having sharp inside corners are not easily achieved, except by hand grinding and filing, making them too costly. Additionally, the apparatus does not allow for coating the underside of the core or for producing starter strips.

Both of these apparatus and methods are intended to be set up and operated in a dedicated facility with an area set up for their use requiring costly floor space. Neither of the apparatus allow for the convenience of portability to the actual construction site.

Therefore, there is a need to develop a method and apparatus for coating the cored workpieces that can be portable and is equipped with a drive mechanism and coating chamber that is not prone to the difficulties encountered with the above two designs.

### SUMMARY OF THE INVENTION

It is therefore an object of the present invention to provide a novel method and apparatus for applying a plaster/stucco-like coating material to the surfaces of an elongate foam core. The foam core is preformed with a profile resembling the desired finish surface profile and may or may not have a reinforcing mesh applied to its surface prior to coating.

The coated foam core can be used for starter strips or decorative mouldings

Accordingly, the present invention discloses a method for applying a plaster/stucco-like coating to the surfaces of an elongate foam core comprising the steps of:
Continuously advancing the core in a straight horizontal plane, with one or more contact wheels driven manually with a crank handle or driving it from the underside with a chain or belt.
In the case of a starter strip, continuously advancing the strip core through a one-piece combination open sided coating chamber/template, coating the edge and a portion of the top surface (usually four inches wide along the length adjacent to the side edge).
In the case of a starter strip, adjusting the one piece coating chamber/template vertically to accommodate a range of thicknesses.
Using a thin steel blade at the edge of the combination coating chamber to prevent the coating material from leaking past the section to be coated.
Constraining the said cores laterally, while inside a coating chamber, as the core advances through an input and output template as a plaster/stuccolike material is applied to the surfaces of the core.
Supporting the said core, while inside a coating chamber, vertically with ledges that adjust to slide under the bottom sides by approximately one-half inch.
Advancing the core through an input template opening made of steel or plastic with an opening corresponding to the profile of the core and large enough to accommodate the core with enough clearance to allow the core to pass through the input template even if the core had been previously coated.
Advancing the core through an output template conforming to the desired finish profile. The core being preformed to a shape conforming to the desired profile but correspondingly smaller by an amount equal to the desired thickness of the coating.
Filling the coating chamber with plastic/stucco-like material by first inserting the foam core so that the input and output template openings are filled with the core, and keeping the coating chamber filled as the cores advance through, one after the other.
Advancing the coated core on to a roller conveyor or slotted table top or flat table top and removing the core from the apparatus and placing the coated cores on racks or tables to dry.
Inserting the coated and dried cores back into the apparatus for a subsequent coating with a thinner or finer grained coating material to provide smoother surface.
Raising the output template slightly when applying a subsequent coating.

A further object of the present invention is to provide an apparatus for applying a plaster/stucco-like coating material to the surface of a profiled elongate foam core, said apparatus comprising:
Means for advancing a core on a straight horizontal plane through the apparatus.
Means of constraining the core laterally as it advances through the apparatus.
Means to allow adjustment of the apparatus to take various size cores.
Means to allow configuration of a coating chamber to provide a coating on the exposed surfaces only of a core.
Means to allow any width of starter strip core to pass through a coating chamber, coating a section of the top surface and adjacent edge of the core.
Means to allow said apparatus to be portable with easily removable and packaged components.
Means of imparting a surface profile on the core surface by the use of a coating chamber with input and output templates.
Means of adjusting the coating thickness with vertically sliding templates. Interchangeable templates usable on other apparatuses that produce starter strips and decorative mouldings designed by the inventor.
Means of providing easy cleanout of the said coating chamber.

### BRIEF DESCRIPTION OF THE DRAWINGS

FIG. 1 is a perspective view of an apparatus of the present invention showing a starter strip core advancing through the machine. The core is shown in thin outline and transparent.

FIGS. 2A, 2B and 2C are perspective views of a starter strip and two decorative mouldings. The layers comprising the surfaces are shown staggered to reveal the core, mesh and one coating layer applied by the invention.

FIG. 3 is an end view looking at the core as passes between the input side guides, under the contact wheel and into the coating chamber.

FIG. 4 is an end view looking at the core inside the coating chamber being laterally aligned between two guide blocks.

FIG. 5 is a perspective view of another embodiment of the apparatus configured to coat decorative mouldings. Input and output templates, baffle plate and second sidewall are added. The core is shown in thin outline and transparent.

FIG. 6 is and end view looking at the core inside the coating chamber being laterally aligned between two guide blocks and with a baffle plate inserted.

FIG. 7 is a perspective view of another embodiment of the apparatus whereby the advancement of the core is achieved with driving dogs attached to a chain and sprocket that penetrate the core from the underside.

### DETAILED DESCRIPTION OF THE PREFERRED EMBODIMENTS

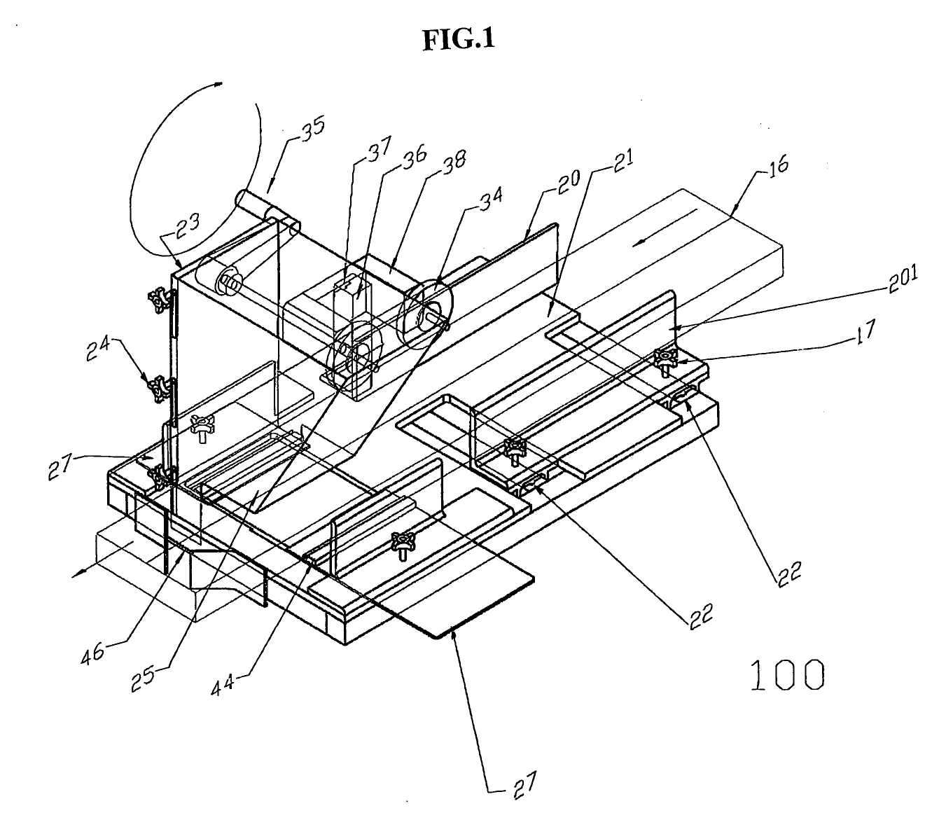

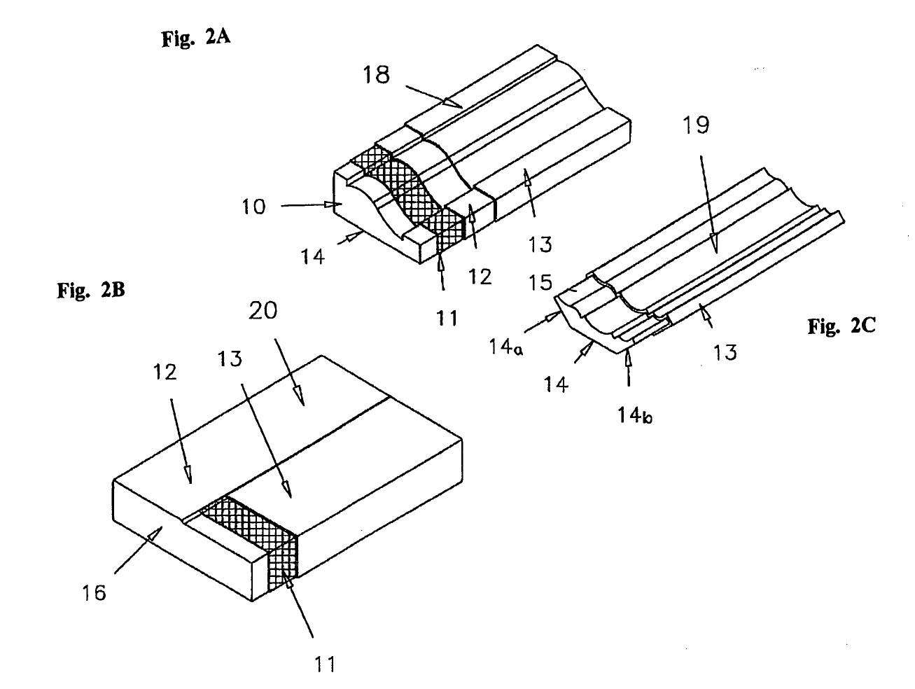

Referring to FIG. 1, there is illustrated the apparatus 100 of the present invention in which a starter strip is coated. The workpiece comprises a core 16 (FIG. 2) having coated surface 13 (FIG. 2) which may be undercut in cross-section, but elongated and consistent along its entire length. If the core is undercut under surface 13, the application of the coating brings surface 13 flush to the uncoated surface 12. A bottom surface 14 (FIG. 2) may be flat or also undercut as surface 13. The bottom undercut surface can be coated by flipping the workpiece over and passing it through the apparatus a second time or at the same time by adding a pan the underside of the coating chamber (not shown). The starter strip core 16 can also be made without the undercut, which in this case will result with coated surface 13 being higher than the uncoated surface 12 by the thickness of the coating. A mesh 11 (FIG. 2) covers the surface 13 (FIG. 2) before coating of the workpiece and may overlap the sides to fold under on to surface 14 (FIG. 2). The mesh acts as reinforcement to the workpiece but may be absent in mesh-less systems or advanced coatings with an inherent fibrous matrix.

The workpiece 18 (FIG. 2) is a decorative moulding designed to be mounted on an exterior wall by cementing it in place via bottom surface 14. Workpiece 19 (FIG. 2) is an interior inside corner moulding and is attached by cementing surfaces 14a and 14b to a wall section.

Apparatus 100 as shown on FIG. 1 is configured to take a starter strip core 16.

Referring to FIG. 1, the foam core 16 is placed on table 21 and pushed by hand to go under contact drive wheels 34 and between the two side guides 20 and 201. The contact drive wheels 34 are connected to a column 36 that allows for adjusting to different heights of cores 16. The side guides 20 and 201 slide on two rails 22 or slots to lightly clamp and align the cores. After the side guides 20 & 201 are adjusted to the width of the core, hand knobs 41 are turned to lock the sliding guide 20 and 201 in place.

Once the core is pushed into the side guides 20 and 201, and under the contact wheels 34, rotating the crank handle 35 rotates the axle through a bearing housing 38 and chain and sprocket to rotate both contact wheels 34, driving the core 16 further along horizontally. The bearing housing 38 is attached to a linear slide 37 that slides up and down on column 36. Proper downward driving pressure is applied to the contact wheels and core. Linear slide 37 has a locking mechanism to maintain the proper downward pressure.

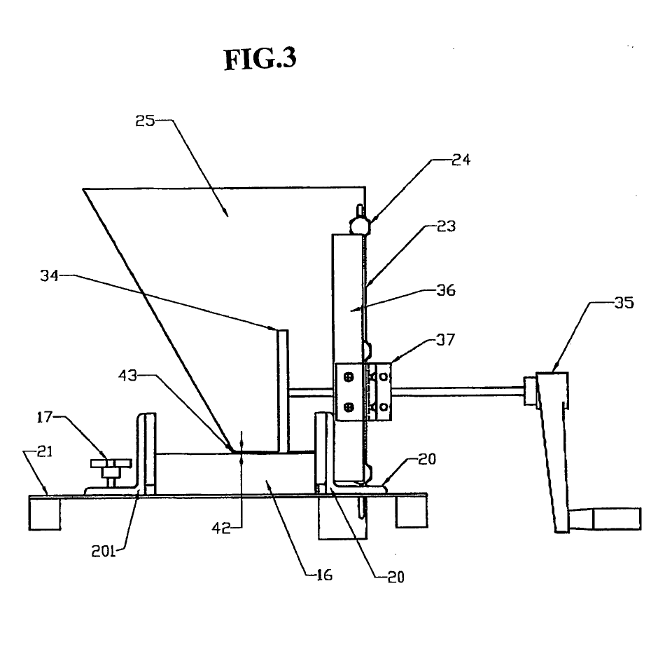

The leading edge of the core 16 passes through the side guides 20 and 201 and continues on under the combination coating chamber/template 25 (CCT). See FIG. 3 of the section view of core 16 as it leaves the side guides 20 and 201, looking towards the CCT.

Referring to FIG. 3, core 16 advances under and into the coating chamber, which is defined as having a sidewall 23 with a combination coating chamber/template 25, open at the top and bottom. The CCT 25 is adjusted slightly higher than the core 16. The clearance 42 has to be enough so that the core does not catch on the template, as it is advanced foreword. A blade 43 lightly engages the surface of the core 16 and prevents leakage of coating material.

Referring to FIG. 3, the CCT is held to the sidewall 23 with screw knobs 24. The screw holes on the CCT are slotted to allow to vertical adjustment to accommodate different core heights.

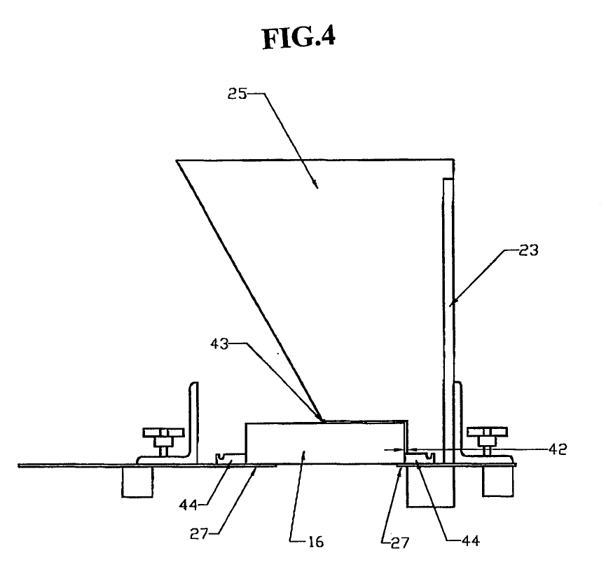

Referring to FIG. 4, the core 16 continues to advance through the CCT. The core 16 is supported on the bottom surface by two laterally adjustable support plates 27, which extend approximately one-half inch under the bottom of the core. The core advances over the support plates 27 and creates a seal along the bottom that prevents the coating material from escaping out the bottom of the CCT as long as a core 16 is present. By having a support plate extending under by only one-half inch, friction that would be encountered with a continuous supporting surface is greatly reduced.

Referring to FIG. 4, the core 16 advances between two opposing guide blocks 44, which are connected to the top of sliding ledges 27. The sliding ledges adjust laterally to align the core 16 through the CCT so that the clearance 42 between the core and the template edge is correct.

The core 16 is advanced so that the leading edge extends past the CCT. At this point, and if this is the first core being coated, the CCT is filled with the coating material. The coating material is contained within the CCT because the sidewall 23, the CCT 25, the core 16 and the support plates 27 restricts its escape. Cores are then advanced through the apparatus one after the other butted end to end. As the cores are pushed out of the apparatus, they pass over scraper wire 46 (FIG. 1) that removes any excess material that may have leaked on to the bottom.

When the last core 16 passes through the CCT, the ledge seal between the core 16 and support plate 27 no longer exists and the excess coating material is free to fall through into a collection pail.

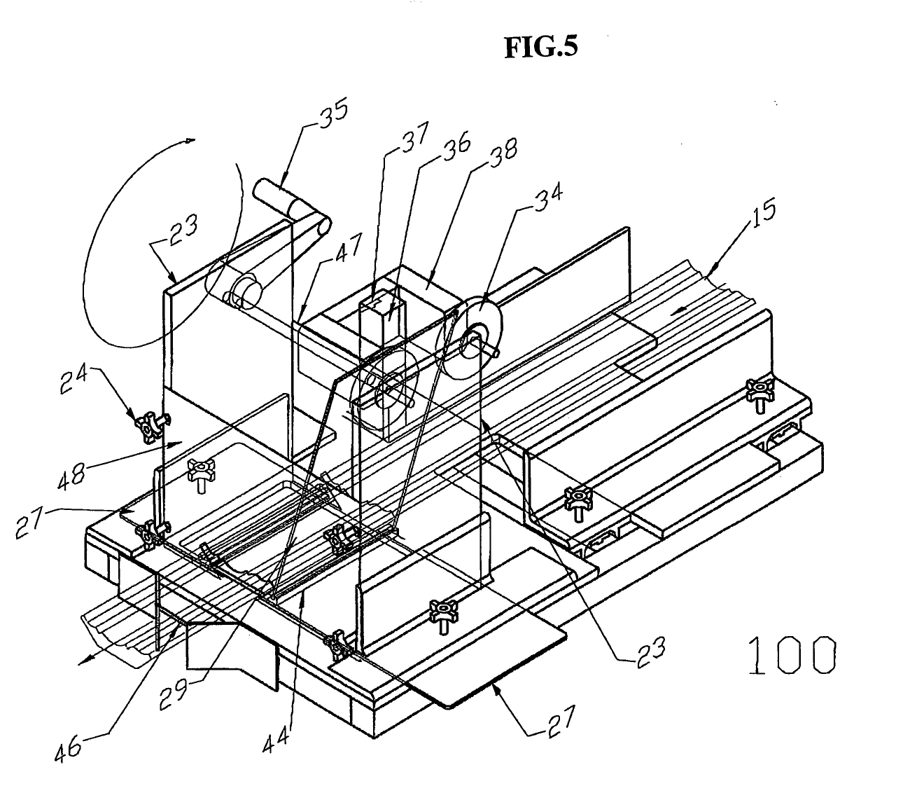

Another embodiment of the present invention is illustrated on FIG. 5. In this embodiment the apparatus is used to coat a decorative moulding core 15. The coating process is more elaborate than coating starter strips because the surface finish has to be better.

Referring to FIG. 5, instead of a CCT, the coating chamber consists of an input template 47 and output template 48. The templates are attached to the sidewalls 23 with hand knobs 24. Both templates have slotted screw holes that allow them to be set to vary the coating thickness.

The input template 47 is cut with a profile slightly larger than the core 15 with enough space between the core and the template to allow subsequent passes through the apparatus with each pass increasing the total coating thickness.

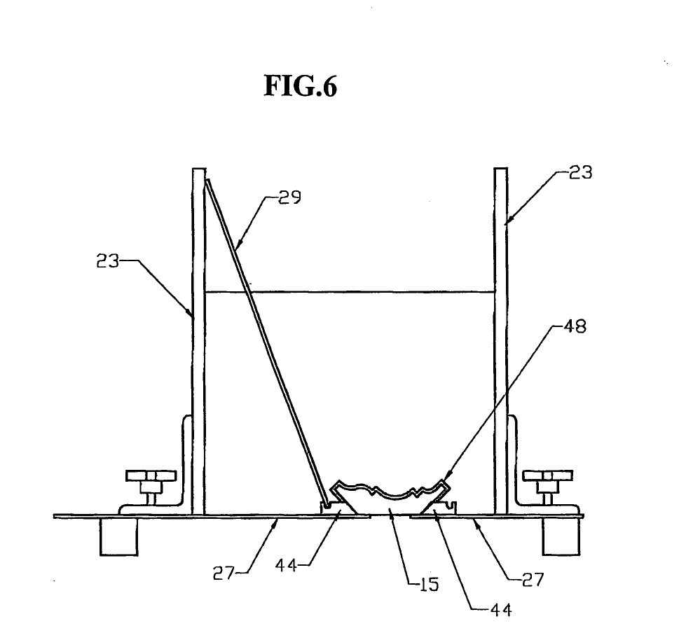

Referring to FIG. 6, the output template 48 is sized to the desired dimension of the finish workpiece 18,19 (FIG. 2). The core 10,15 FIG. 2 was preformed smaller than the finished workpiece by an amount equal to the desired coating thickness.

Referring to FIG. 6, the core 15 is shown inside the coating chamber. Two guide blocks 44 locate the core laterally and vertically to keep it tracking as it advances through to the output template 48. The guide block is profiled to conform to the core shape. The guide blocks can be made profiled to match any core shape required.

The guide blocks 44 (FIG. 6) have a groove on top. Baffle plate 29 (FIG. 6) fits into this groove and leans against the sidewall 23. The left and right support plates are extended to reach under the core 15 to provide a support ledge.

Since the sidewalls 23 are fixed, templates 47 and 48 are all the same width regardless of the shapes and sizes of the decorative moulding workpieces. This can result with a large space on the left side of the coating chamber that would be filled with the coating material. The baffle plate 29 (FIG. 6) funnels the material away from the left sidewall, thus resulting in less material wasted to just fill the coating chamber.

As the core advances past the output template 48, wire 46 (FIG. 5) removes any excess material that may have squeezed on to the bottom edge 14 (FIG. 2) of the workpiece.

As with the first embodiment, cores are fed through the apparatus one after the other, end to end. However the decorative moulding will most likely have to be coated more than once with progressively finer grit coating material until the desired finish is achieved. The templates 47 and 48 can be raised slightly after each pass to increase the thickness of the coating.

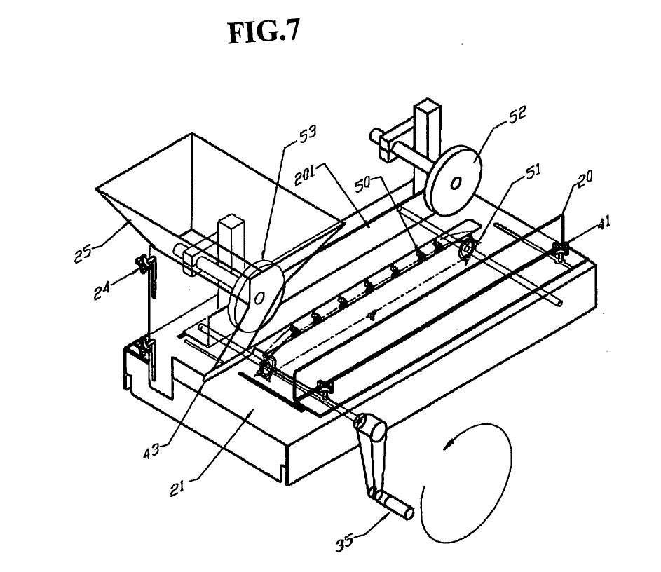

A third embodiment of apparatus 100 is shown on FIG. 7. The apparatus is configured for starter strips, but is also able to be set up for decorative mouldings. In this case, the core is advanced by driving dogs 50 that are connected to a chain and sprocket assembly 51.

The core is inserted between the two side guides 21 and 201 and is held down against the tabletop by hold down roll 52. Handle 35 is rotated which drives the chain and sprocket assembly 51. The drive dogs penetrate the underside of the core and advance it forward under a second hold down roll 53 before entering the CCT.

Hold down rolls adjust vertically to accommodate different core thicknesses and laterally to allow for profile variations. The tabletop has an opening to replace the sliding ledge and slots allowing the template to extend below the table surface.

In all other respects, this embodiment functions the same as the first two.

While many specific structural details have been disclosed, it will be understood that it is capable of many modifications and that this application is intended to cover any variation, uses, adaptions of the invention, following in general the principles of the invention including such departures from the present disclosure as to come within the knowledge of customary practice in the art, and as may be applied to the essential features hereinbefore set forth and falling within the scope of the invention or the limits of the appended claims.

1. A method for applying a coating material to the surface of an elongated foam core, said method comprising the steps of:
(a) continuously advancing said core in a straight horizontal plane by drive means;
(b) coating an edge in a portion of the top surface of said core with said coating material;
(c) applying said coating material to the surface of said core;
(d) advancing said core to an input template;
(e) advancing said core through an output template; and
(f) removing and drying said coated core.

2. A method as claimed in claim 1 wherein said coating material is selected from a group consisting of plaster, stucco or cement-like mixture.

3. A method as claimed in claim 1 wherein said foam core is a starter strip.

4. A method as claimed in claim 1 wherein said core is a decorative moulding.

5. A method as claimed in claim 1 wherein said drive means is one or more contact wheels driven by a crank handle.

6. A method as claimed in claim 1 wherein said drive means is a chain or belt underneath said foam core and is adapted to advance said core.

7. A method as claimed in claim 1 wherein said core is made from pre-formed expanded polystyrene.

8. A method as claimed in claim 1 wherein said core is continuously and contiguously coated.

9. A method as claimed in claim 1 wherein said foam core is pre-formed with a profile resembling the desired finish surface profile.

10. A method as claimed in claim 1 wherein a reinforcing mesh is applied to the surface of said core prior to coating.

11. A method as claimed in claim 8 wherein said coating material is prevented from leaking past each coated foam core.

12. A method as claimed in claim 1 wherein said method is repeated using a second coating material.

13. An apparatus for applying a coating material to a plurality of elongated foam cores, said apparatus comprising:
(a) advancing means for advancing said plurality of cores on a straight horizontal plane;
(b) constraining means for constraining the said plurality of cores in a lateral direction as said cores advance;
(c) coating means for coating a coating material on exposed surfaces of said foam cores;
(d) input and output templates for imparting a surface profile on said coated core surface; and
(e) drying means for drying said coated core.

14. An apparatus as claimed in claim 13 further including drive means for advancing said cores through said apparatus.

15. An apparatus as claimed in claim 14 wherein said drive means is a variable speed electric, pneumatic or hydraulic motor.

16. An apparatus as claimed in claim 14 wherein said drive means is a manual crank.

17. An apparatus as claimed in claim 14 wherein said drive means is a chain or belt underneath said core and is adapted to advance said core.

18. An apparatus as claimed in claim 13 wherein said input and output templates are a one-piece combination open sided coating chamber which is adjustable to accommodate a range of thicknesses of said core.

19. An apparatus as claimed in claim 18 further including a steel blade in said chamber to prevent the coating material from leaking past the coated core.
